(19) United States
(12) Patent Application Publication
(10) Pub. No.: US 2024/0125902 A1
(43) Pub. Date: Apr. 18, 2024

(54) SPATIAL LIGHT MODULATOR AND LiDAR DEVICE INCLUDING THE SAME

(71) Applicants: SAMSUNG ELECTRONICS CO., LTD., Suwon-si (KR); POSTECH Research and Business Development Foundation, Pohang-si (KR)

(72) Inventors: Sunil KIM, Suwon-si (KR); Junsuk RHO, Pohang-si (KR); Younghwan YANG, Pohang-si (KR); Junghyun PARK, Suwon-si (KR)

(73) Assignees: SAMSUNG ELECTRONICS CO., LTD., Suwon-si (KR); POSTECH Research and Business Development Foundation, Pohang-si (KR)

(21) Appl. No.: 18/219,448

(22) Filed: Jul. 7, 2023

(30) Foreign Application Priority Data
Oct. 17, 2022 (KR) 10-2022-0133610

(51) Int. Cl. G01S 7/481; G01S 17/08; G02F 1/21

(52) U.S. Cl. CPC G01S 7/4814; G01S 17/08; G02F 1/21; G01S 17/931

(57) ABSTRACT

Provided is a spatial light modulator configured to modulate light, the spatial light modulator including a first reflective layer, a resonance layer on the first reflective layer, and a second reflective layer on the resonance layer, the second reflective layer including a plurality of grating structures space apart from each other, wherein the plurality of grating structures include silicon (Si) having an extinction coefficient k that is less than or equal to 1e-5 with respect to light in the predetermined wavelength band.

### CROSS-REFERENCE TO RELATED APPLICATION

This application is based on and claims priority under 35 U.S.C. § 119 to Korean Patent Application No. 10-2022-0133610, filed on Oct. 17, 2022, in the Korean Intellectual Property Office, the disclosure of which is incorporated by reference herein in its entirety.

### BACKGROUND

### 1. Field

Example embodiments of the disclosure relate to a spatial light modulator and a light detection and ranging (LiDAR) device including the same.

### 2. Description of Related Art

Advanced driving assistance systems (ADASs) having various functions have been commercialized. For example, there is a tendency of increasing the number of vehicles equipped with functions, such as an adaptive cruise control (ACC) which reduces the speed of a vehicle if there is a risk of collision and the vehicle is driven within a set speed range if there is no risk of collision by recognizing a location and speed of another vehicle, and an autonomous emergency braking system (AEB) which automatically applies braking to prevent collisions when there is a risk of collision by recognizing the vehicle in front, but the driver does not respond to the risk or the response method is inappropriate. In addition, it is expected that automobiles capable of autonomous driving will be commercialized in the near future.

Accordingly, the importance of a vehicle radar that provides information about a vehicle's surroundings is gradually increasing. For example, a light detection and ranging (LiDAR) device for a vehicle emits a laser to a selected area around the vehicle, detects the reflected laser, and provides information about a distance, relative speed, and azimuth to objects around the vehicle. To this end, the LiDAR device for a vehicle requires a beam steering technology that may steer light to a desired area.

The beam steering method is largely divided into a mechanical method and a non-mechanical method. For example, the mechanical beam steering method includes a method of rotating a light source itself, a method of rotating a mirror reflecting light, a method of moving a spherical lens in a direction perpendicular to an optical axis, and the like. In addition, the non-mechanical beam steering method includes a method of using a semiconductor element and a method of electrically controlling an angle of reflected light by using a reflective phase array.

The mechanical method is bulky, and there are issues, such as vibration and noise. In the non-mechanical method, a method of reducing light loss caused by material characteristics is sought.

### SUMMARY

One or more example embodiments provide a spatial light modulator with improved light efficiency.

One or more example embodiments also provide a method of manufacturing a spatial light modulator with improved light efficiency.

One or more example embodiments also provide a light detection and ranging (LiDAR) device using a spatial light modulator.

Additional aspects will be set forth in part in the description which follows and, in part, will be apparent from the description, or may be learned by practice of the presented example embodiments of the disclosure.

According to an aspect of an example embodiment, a spatial light modulator configured to modulate light, includes: a first reflective layer; a resonance layer on the first reflective layer; and a second reflective layer on the resonance layer, the second reflective layer including a plurality of grating structures spaced apart from each other, wherein the plurality of grating structures include silicon (Si) having an extinction coefficient k that is less than or equal to 1e-5 with respect to light in a predetermined wavelength band.

The silicon may be deposited under a process in which a gas flow rate of hydrogen (H2) is at least twice a gas flow rate of silane (SiH4).

The first reflective layer may be a distributed Bragg reflective layer.

The distributed Bragg reflective layer may include silicon (Si), silicon nitride (SiN), silicon oxide (SiO2), or titanium oxide (TiO2).

The first reflective layer may be a metal reflective layer.

The resonance layer may include silicon oxide (SiO2).

Each of the plurality of grating structures may include: a first type semiconductor layer; a second type semiconductor layer; and an intrinsic semiconductor layer between the first type semiconductor layer and the second type semiconductor layer.

A thickness of the first type semiconductor layer and a thickness of the second type semiconductor layer may be in a range from 50 nm to 200 nm, and a thickness of the intrinsic semiconductor layer may be in a range from 100 nm to 600 nm.

A reflectance of the second reflective layer may be less than a reflectance of the first reflective layer.

The spatial light modulator may further include a first electrode and a second electrode that are configured to apply a voltage to the plurality of grating structures.

The spatial light modulator may further include a dielectric layer on an upper surface of the resonance layer and around the plurality of grating structures.

A refractive index of the dielectric layer may be less than a refractive index of each of the plurality of grating structures.

The dielectric layer may include at least one of silicon oxide (SiO2) and silicon nitride (SiN).

According to an aspect of an example embodiment, a light detection and ranging (LiDAR) device includes: a light source configured to emit light of a predetermined wavelength band; a spatial light modulator configured to adjust a traveling direction of the light emitted from the light source toward an object; and a photodetector configured to detect light reflected from the object, wherein the spatial light modulator includes: a first reflective layer; a resonance layer on the first reflective layer; and a second reflective layer on the resonance layer, the second reflective layer including a plurality of grating structures spaced apart from each other, and wherein the plurality of grating structures include silicon (Si) having an extinction coefficient k that is less than or equal to 1e-5 with respect to light of the predetermined wavelength band.

The silicon (Si) may be deposited under a process in which a gas flow rate of hydrogen (H2) is at least twice a gas flow rate of silane (SiH4).

According to an aspect of an example embodiment, a method of manufacturing a spatial light modulator, includes: forming a resonance layer on a first reflective layer; forming a semiconductor layer on the resonance layer; forming a plurality of grating structures spaced apart from each other by patterning the semiconductor layer; and heat-treating the plurality of grating structures, wherein the forming the semiconductor layer is performed so that an extinction coefficient (k) of silicon (Si) included in the semiconductor layer with respect to light in a predetermined wavelength band is less than or equal to 1e-5.

The silicon (Si) may be formed by a process in which a gas flow rate of hydrogen (H2) is at least twice a gas flow rate of silane (SiH4).

The method may further include filling a dielectric layer between the plurality of grating structures.

The heat-treating the plurality of grating structures may include heating the plurality of grating structures at a temperature in a range from 500° C. to 650° C. for 8 hours to 12 hours.

The heat-treating the plurality of grating structures may further include heating the heat-treated plurality of grating structures at a temperature greater than or equal to 750° C. within 10 minutes.

### BRIEF DESCRIPTION OF THE DRAWINGS

The above and other aspects, features, and advantages of certain example embodiments of the disclosure will be more apparent from the following description taken in conjunction with the accompanying drawings, in which:

FIG. 1 is a cross-sectional view illustrating a spatial light modulator according to an example embodiment;

FIG. 2 is a graph illustrating a change in an extinction coefficient of a spatial light modulator according to a wavelength;

FIG. 3 is a graph showing a full width half maximum (FWHM) of a spatial light modulator according to an extinction coefficient;

FIG. 4 is a graph showing power consumption of a spatial light modulator according to the FWHM;

FIG. 5 is a diagram showing a cross-section of a grating structure according to an example embodiment;

FIG. 6 is a diagram showing a cross-section, in another direction, of a grating structure according to an example embodiment;

FIGS. 7A, 7B, 7C, 7D, and 7E are diagrams for explaining a method of manufacturing a spatial light modulator according to an example embodiment;

FIG. 8 is a schematic block diagram showing a configuration of a LiDAR device according to an example embodiment;

FIG. 9 is a schematic block diagram showing a configuration of a LiDAR device according to another example embodiment; and

FIGS. 10 and 11 are conceptual views illustrating a case in which a LiDAR device including a spatial light modulator according to an embodiment is applied to a vehicle.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, a spatial light modulator and a light detection and ranging (LiDAR) device will be described more fully with reference to the accompanying drawings. In the drawings, like reference numerals refer to like elements, and sizes of elements may be exaggerated for clarity and explanation convenience of the specification. The embodiments of the disclosure are capable of various modifications and may be embodied in many different forms.

When an element or layer is referred to as being “on” or “above” another element or layer, the element or layer may be directly on another element or layer or intervening elements or layers. The singular forms are intended to include the plural forms as well, unless the context clearly indicates otherwise. When a portion “includes” an element, another element may be further included, rather than excluding the existence of the other element, unless otherwise described.

The term “above” and similar directional terms may be applied to both singular and plural. With respect to operations that constitute a method, the operations may be performed in any appropriate sequence unless the sequence of operations is clearly described or unless the context clearly indicates otherwise. The operations may not necessarily be performed in the order of sequence.

Connecting lines or connecting members between the components shown in the drawings are merely illustrative of functional connections and/or physical or circuit connections. In a practical device, the connections between the components may be represented by various functional connections, physical connections, or circuit connections that may be replaced or added.

All examples or example terms are simply used to explain in detail the technical scope of the disclosure, and thus, the scope of the disclosure is not limited by the examples or the example terms as long as it is not defined by the claims.

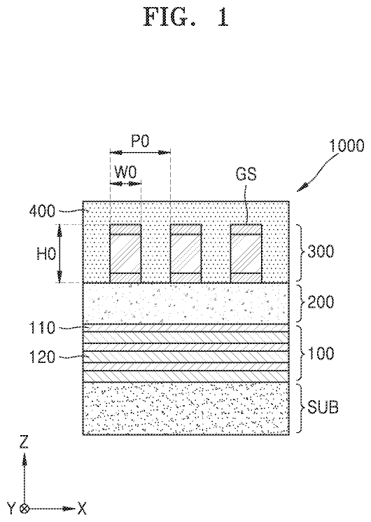

FIG. 1 is a cross-sectional view illustrating a spatial light modulator 1000 according to an example embodiment.

Referring to FIG. 1, the spatial light modulator 1000 may include a first reflective layer 100 configured to modulate light of a predetermined wavelength band, a resonance layer 200 disposed on the first reflective layer 100, and a second reflective layer 300 including a plurality of grating structures GS disposed to be spaced apart from each other on the resonance layer 200.

The spatial light modulator 1000 may output incident light after modulating a phase of the incident light. The spatial light modulator 1000 may include a plurality of pixels. A pixel may represent the smallest unit independently driven in the spatial light modulator 1000 or a basic unit capable of independently modulating a phase of light. The pixel may include a plurality of grating structures GS included in the second reflective layer 300. One pixel may include a plurality of grating structures GS.

The spatial light modulator 1000 may further include a substrate SUB supporting the first reflective layer 100 and provided opposite to the resonance layer 200. The substrate SUB may be a transparent substrate that transmits light. For example, the substrate SUB may include, for example, a silicon substrate or a glass substrate. The substrate SUB may be an optional component and may be removed as needed.

The first reflective layer 100 may be a distributed Bragg reflector. For example, the first reflective layer 100 may include a first layer 110 and a second layer 120 having different refractive indices. The first layer 110 and the second layer 120 may be alternately and repeatedly stacked. Due to the difference in refractive index between the first layer 110 and the second layer 120, light is reflected at an interface of each layer, and the reflected light may cause interference. The first layer 110 and the second layer 120 may include, for example, silicon (Si), silicon nitride (Si₃N₄), silicon oxide (SiO₂), or titanium oxide (TiO₂). For example, the first layer 110 may be include silicon (Si), and the second layer 120 may include silicon oxide (SiO₂). The light reflectivity of the first reflective layer 100 may be designed by adjusting the thickness and/or the number of stacks of the first layer 110 and the second layer 120.

In the example embodiment described above, as an example of the first reflective layer 100, the distributed Bragg reflector layer has been mainly described, but embodiments are not limited thereto. The first reflective layer 100 may have a structure other than the distributed Bragg reflector layer, for example, the first reflective layer 100 may be a metal reflective layer having at least one surface including a metal.

The resonance layer 200 may be a region in which incident light resonates, and may be disposed on the first reflective layer 100. The resonance layer 200 may be disposed between the first reflective layer 100 and the second reflective layer 300. The resonance wavelength of the resonance layer 200 may be determined according to the thickness of the resonance layer 200. As the thickness of the resonance layer 200 increases, the resonance wavelength of light may become longer, and as the thickness of the resonance layer 200 decreases, the resonance wavelength of light may become shorter. The resonance layer 200 may include, for example, silicon oxide (SiO₂).

The second reflective layer 300 may be designed to appropriately perform a reflection function of reflecting light of a specific wavelength and a phase modulation function of modulating a phase of emitting light. The reflectance of the second reflective layer 300 may be different from the reflectance of the first reflective layer 100, and the reflectance of the second reflective layer 300 may be lower than the reflectance of the first reflective layer 100.

The second reflective layer 300 may include a plurality of grating structures GS arranged to be spaced apart from each other at predetermined intervals. The reflection and transmission of light may be controlled by adjusting a width W0, a height H0, an interval P0, etc. of the plurality of grating structures GS. The grating structure GS may have a refractive index greater than the refractive index of a surrounding material.

The grating structure GS may include, for example, silicon (Si). Silicon constituting the grating structure GS may have an amorphous or polycrystalline structure by heat treatment. Silicon constituting the grating structure GS may be deposited by plasma enhanced chemical vapor deposition (PECVD) or low pressure chemical vapor deposition (LPCVD).

An extinction coefficient (k) of silicon included in the grating structure GS with respect to light in a predetermined wavelength band may have a value less than or equal to 1e-5. For example, the extinction coefficient k for light of a wavelength band to be modulated by the spatial light modulator 1000 may be less than or equal to 1e-5. The wavelength band may be in a range from about 800 nm to about 1700 nm, and the wavelength band may be in a range from about 850 nm to about 1100 nm. The extinction coefficient k may be expressed as an imaginary part of a refractive index. The extinction coefficient k is related to absorptivity, and the larger the extinction coefficient k, the greater the light loss. The grating structure GS provided in the spatial light modulator 1000 according to an example embodiment has a relatively very small extinction coefficient k for light of a wavelength band to be modulated, and thus, there may be relatively a small amount of optical loss.

The extinction coefficient k of silicon included in the grating structure GS with respect to light in a predetermined wavelength band may be determined by a gas flow ratio of hydrogen (H₂) and silane (SiH₄) during a deposition process of forming the grating structure GS when the spatial light modulator 1000 is manufactured. As the flow rate of H₂ with respect to SiH₄ increases, the extinction coefficient k decreases. For example, the flow rate of H₂ with respect to the flow rate of SiH₄ may be 2 to 10 times greater or more. The extinction coefficient k of silicon included in the grating structure GS with respect to light of a predetermined wavelength band may be determined by a process pressure. The process pressure may be determined between 0.5 and 5 torr. The extinction coefficient k of silicon included in the grating structure GS with respect to light of a predetermined wavelength band may be determined by a process temperature. The process temperature may be determined in a range from about from 100° C. to about 450° C. Process conditions, such as the gas flow ratio of H₂ with respect to SiH₄, the process pressure, and the process temperature may vary depending on equipment.

The width W0 of the plurality of grating structures GS may be in a range from about 300 nm to about 500 nm. The height H0 of the plurality of grating structures GS may be in a range from about 550 nm to about 650 nm. The interval P0 between the plurality of grating structures GS may be in a range from about 700 nm to about 770 nm. However, the width W0, the height H0, and the interval P0 of the plurality of grating structures GS are not necessarily limited thereto, and may vary depending on the wavelength of light to be modulated.

The refractive index of the grating structure GS may be changed by heat. Resonance characteristics are changed according to a change in the refractive index, thus the phase of light emitted to the outside may be adjusted. A current may be applied to the grating structure GS so that the grating structure GS is heated, and, to this end, the grating structure GS may include one of a silicon semiconductor-based PIN structure, a NIN structure, and a PIP structure. For example, the grating structure GS includes a stacked structure of a p-type silicon layer, an intrinsic silicon layer, and an n-type silicon layer, a stacked structure of an n-type silicon layer, an intrinsic silicon layer, and an n-type silicon layer, or a stacked structure of a p-type silicon layer, an intrinsic silicon layer, and a p-type silicon layer. Metal electrodes may be connected to upper and lower portions of the grating structure GS to apply a current to the grating structure GS.

The spatial light modulator 1000 may further include a dielectric layer 400 filled between the plurality of grating structures GS. The dielectric layer 400 may be in contact with an upper surface of the resonance layer 200 while being provided adjacent to and surrounding the plurality of grating structures GS. The dielectric layer 400 may include a material having a refractive index less than that of the grating structure GS. For example, when the grating structure GS includes silicon, the dielectric layer 400 may include at least one of silicon oxide and silicon nitride. The dielectric layer 400 may include the same material as that of the resonance layer 200. The dielectric layer 400 may protect the grating structure GS during a manufacturing operation.

Light incident to the spatial light modulator 1000 passes through the second reflective layer 300, propagates to the resonance layer 200, is reflected by the first reflective layer 100, resonates by being trapped in the resonance layer 200 by the first reflective layer 100 and the second reflective layer 300, and is emitted through the second reflective layer 300. The emitted light may have a specific phase, and the phase of the emitted light may be controlled by the width W0, the height H0, the interval P0 of the grating structure GS constituting the second reflective layer 300, and the refractive index of the grating structure GS. A traveling direction of light may be determined by a phase relationship of light emitted from adjacent pixels.

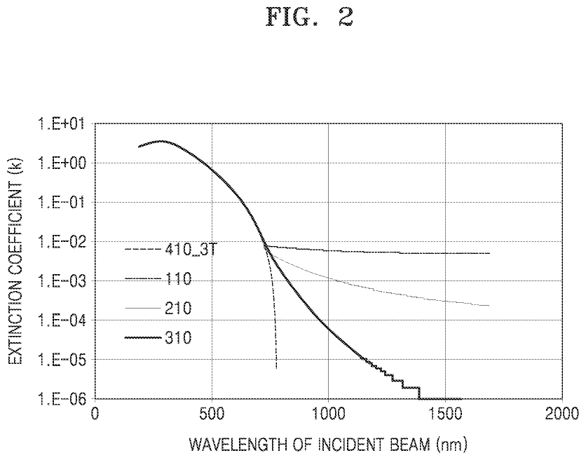

FIG. 2 is a graph illustrating a change in an extinction coefficient k of a spatial light modulator according to a wavelength.

FIG. 2 illustrates a result of measuring the change in the extinction coefficient k of silicon according to a wavelength by varying a flow rate of H₂. The change in the extinction coefficient (k) of silicon according to a wavelength was measured while the flow rate of SiH₄ was fixed at 55 sccm, and the flow rate of H₂ was increased to 110 sccm, 210 sccm, 310 sccm, and 410 sccm. As a result, it may be seen that the extinction coefficient k decreases as the flow rate ratio of H₂ with respect to SiH₄ increases.

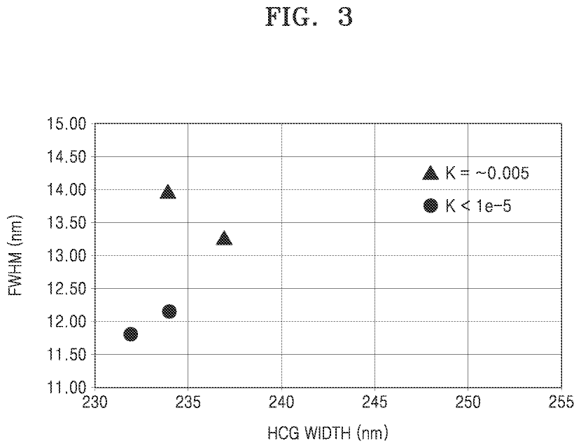

FIG. 3 is a graph showing a full width half maximum (FWHM) of a spatial light modulator according to an extinction coefficient k.

Referring to FIG. 3, a result of measuring the size of the FWHM of the spatial light modulator according to an interval of the grating structures GS with different extinction coefficients k with respect to light of a predetermined wavelength band are shown. When the extinction coefficient k of silicon constituting the grating structure GS with respect to light of a predetermined wavelength band is small, it may be seen that the FWHM of a reflectance curve decreases as the reflectivity of the grating structure GS increases.

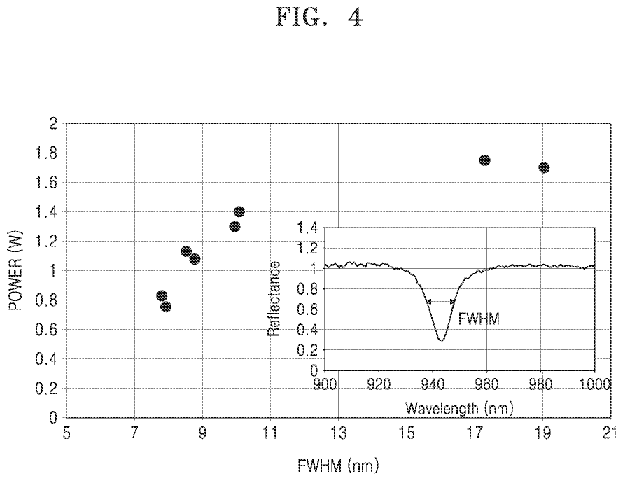

FIG. 4 is a graph showing power consumption of a spatial light modulator according to the FWHM.

FIG. 4 illustrates that the smaller the value of the FWHM, the lower the power consumption for obtaining a highest side mode suppression ratio (SMSR). The SMSR is expressed as the intensity of a primary beam with respect to a zero-order beam intensity, and the higher the SMSR, the higher the directivity of light. As the extinction coefficient k of silicon constituting the grating structure GS with respect to light in a predetermined wavelength band decreases, the reflectance of the grating structure GS increases, which results in the decrease in the FWHM of the reflectance curve, and the smaller the FWHM, the lower the power consumption.

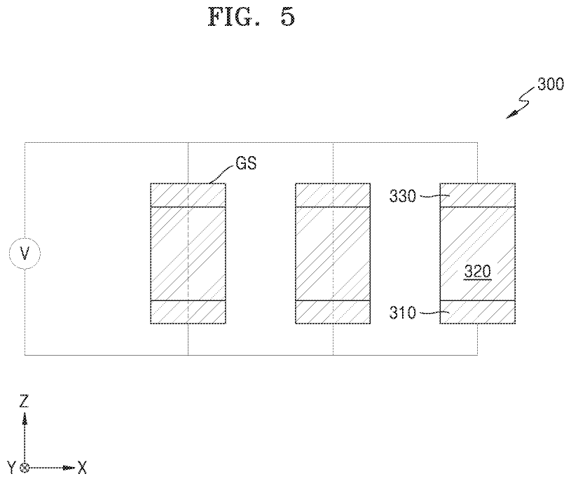

FIG. 5 is a diagram showing a cross-section of a grating structure GS according to an example embodiment.

Referring to FIG. 5, the grating structure GS may include a first type semiconductor layer 310, a second type semiconductor layer 330, and an intrinsic semiconductor layer 320 between the first type semiconductor layer 310 and the second type semiconductor layer 330. For example, the first type semiconductor layer 310 may be an n-type semiconductor layer, the second type semiconductor layer may be a p-type semiconductor layer, and the grating structure GS may be a PIN diode.

The first type semiconductor layer 310 may be a silicon layer including a Group V element as an impurity. For example, the first type semiconductor layer 310 may be a silicon layer including phosphorus (P) or arsenic (As) as an impurity. The concentration of the impurity included in the first type semiconductor layer 310 may be in a range from about 10¹⁵ cm⁻³ to about 10²¹ cm⁻³. The thickness of the first type semiconductor layer 310 may be in a range from about 50 nm to about 200 nm. The intrinsic semiconductor layer 320 may be a silicon layer that does not include an impurity. The intrinsic semiconductor layer 320 may include silicon having an extinction coefficient k of 1e-5 or less. The intrinsic semiconductor layer 320 may have a thickness in a range from about 100 nm to about 600 nm. The second type semiconductor layer 330 may be a silicon layer including a Group III element as an impurity. For example, the second type semiconductor layer 330 may be a silicon layer including boron (B) as an impurity. The concentration of the impurity included in the second type semiconductor layer 330 may be in a range from about 10¹⁵ cm⁻³ to about 10²¹ cm⁻³. The thickness of the second type semiconductor layer 330 may be in a range from about 50 nm to about 200 nm.

When a voltage is applied between the first type semiconductor layer 310 and the second type semiconductor layer 330, a current flows from the first type semiconductor layer 310 to the second type semiconductor layer 330. Heat is generated in the grating structure GS by the flowing current, and the refractive index of the grating structure GS may be changed by the heat. When the refractive index of the grating structure GS is changed, a phase of light emitted from a pixel may be changed, and thus the traveling direction of the light emitted from the spatial light modulator 1000 may be controlled by adjusting the magnitude of the voltage applied to each pixel. Since a phase of emitted light varies depending on a current flowing through the grating structure GS, when the current flowing through the grating structure GS is relatively small, the phase of the light emitted from the spatial light modulator 1000 may be relatively small.

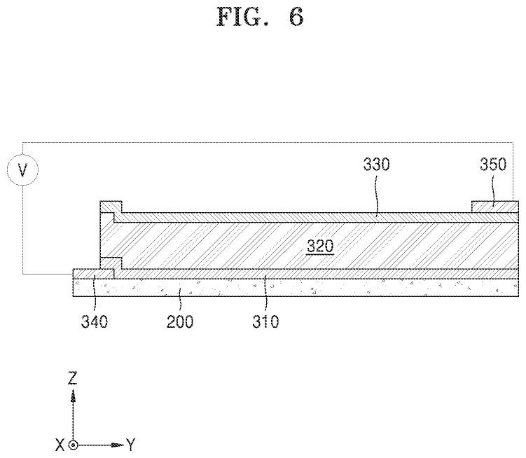

FIG. 6 is a diagram showing a cross-section in another direction of a grating structure GS according to an example embodiment. Referring to FIG. 6, the spatial light modulator 1000 may include a first electrode 340 and a second electrode 350 for applying a voltage to the grating structure GS. The first electrode 340 may contact one end of the first type semiconductor layer 310, and the second electrode 350 may contact one end of the second type semiconductor layer 330. The second electrode 350 may contact an end of the second type semiconductor layer 330 disposed on an opposite side in a Y direction to the end of the first type semiconductor layer 310 in contact with the first electrode 340. The first electrode 340 may be disposed on the resonance layer 200 and may be a common electrode that applies a common voltage to all pixels included in the spatial light modulator 1000. The second electrode 350 may be a pixel electrode designed to apply different voltages to each pixel. FIG. 6 illustrates one grating structure GS, and the same voltage may be applied to the second electrode 350 of the grating structure GS of the same pixel.

Although the grating structure GS of the PIN structure has been described with reference to FIGS. 5 and 6, embodiments are not limited thereto. The grating structure GS may have a NIN structure or a PIP structure. For example, both the first type semiconductor layer 310 and the second type semiconductor layer 330 may be n-type semiconductor layers, or both may be p-type semiconductor layers.

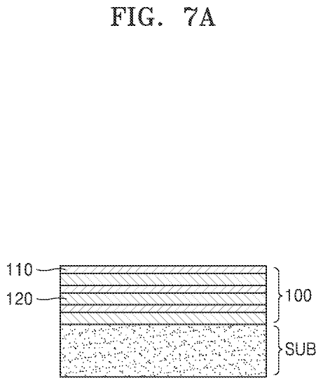

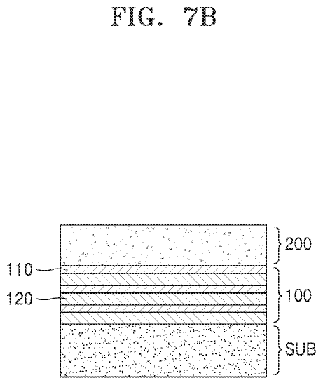

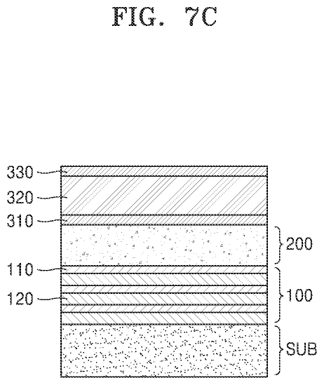

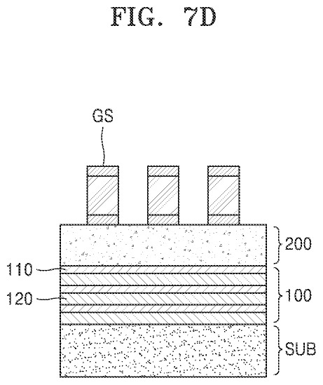

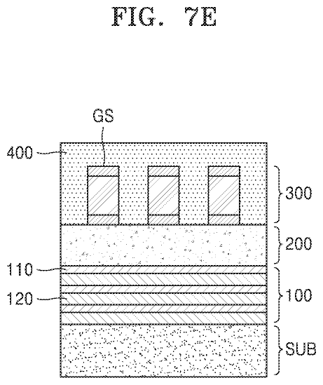

FIGS. 7A to 7E are diagrams for explaining a method of manufacturing a spatial light modulator according to an example embodiment.

Referring to FIG. 7A, a first reflective layer 100 may be formed on a substrate SUB. The substrate SUB may be a substrate including a transparent material that transmits light. For example, the substrate SUB may include a silicon substrate or a glass substrate. The first reflective layer 100 may be a distributed Bragg reflective layer in which first layers 110 and second layers 120 having different refractive indices are alternately stacked. The first reflective layer 100 may be formed by repeatedly stacking the first layer 110 and the second layer 120. The first layer 110 and the second layer 120 may be formed by, for example, plasma chemical vapor deposition (PECVD).

Referring to FIG. 7B, a resonance layer 200 may be formed on the first reflective layer 100. The resonance layer 200 may include, for example, silicon oxide (SiO2). The resonance layer 200 may have a thickness in a range from about of 300 μm to about 1500 μm. The resonance layer 200 may be formed by, for example, plasma chemical vapor deposition (PECVD).

Referring to FIGS. 7C to 7E, a second reflective layer 300 having a plurality of grating structures GS may be formed on the resonance layer 200.

Referring to FIG. 7C, a first type semiconductor layer 310, an intrinsic semiconductor layer 320, and a second type semiconductor layer 330 are sequentially formed on the resonance layer 200. The first type semiconductor layer 310, the intrinsic semiconductor layer 320, and the second type semiconductor layer 330 may be formed by, for example, plasma chemical vapor deposition (PECVD).

The intrinsic semiconductor layer 320 may include silicon (Si) having an extinction coefficient (k) with respect to light in a predetermined wavelength band of 1e-5 or less. The extinction coefficient (k) of silicon included in the intrinsic semiconductor layer 320 with respect to light of a predetermined wavelength band may be determined by a gas flow rate ratio of H₂ to that of SiH₄ during deposition. As the gas flow rate of H₂ with respect to SiH4 increases, the extinction coefficient (k) of silicon (Si) decreases. For example, the gas flow rate ratio of H₂ with respect to SiH₄ may be 2 to 10 times greater or more. The extinction coefficient (k) of silicon included in the plurality of grating structures GS with respect to light in a predetermined wavelength band may be determined by a process pressure. For example, the process pressure may be in a range from about 0.5 torr to about 5 torr. The extinction coefficient (k) of silicon included in the plurality of grating structures GS with respect to light in a predetermined wavelength band may be determined by a process temperature. For example, the process temperature may be in a range from about 100° C. to about 450° C. Process conditions, such as the gas flow rate of H₂ with respect to SiH₄, the process pressure, and the process temperature may vary depending on equipment.

Referring to FIG. 7D, a plurality of grating structures GS spaced apart from each other may be formed by patterning the first type semiconductor layer 310, the intrinsic semiconductor layer 320, and the second type semiconductor layer 330. For example, the plurality of grating structures GS having a predetermined width and interval may be formed through a photolithography process and an etching process.

Referring to FIG. 7E, a dielectric layer 400 may be filled between the grating structures GS. The dielectric layer 400 may be a material having a refractive index less than that of the plurality of grating structures GS. The dielectric layer 400 may protect the plurality of grating structures GS in the manufacturing process. The dielectric layer 400 may contact an upper surface of the resonance layer 200 while being provided adjacent to and surrounding the plurality of grating structures GS. For example, the dielectric layer 400 may be provided on the side and upper surface of each of the grating structures GS.

After the dielectric layer 400 is provided, an additional heat treatment operation may be performed. Silicon included in the grating structure GS has a polycrystalline structure, and heat treatment may be performed so that a height of a part or all of grains of the polycrystalline structure is equal to a thickness of the grating structure GS. For example, the crystal size of the grating structure GS may be increased through heat treatment so that the grains have a columnar shape.

The heat treatment may be performed at a high temperature for a short time or at a low temperature for a long time, followed by an additional heat treatment at a high temperature.

The heat treatment of the grating structure GS may be performed at a low temperature for a relatively long time. For example, the plurality of grating structures GS may be heated at a temperature in a range from about 500° C. to about 650° C. for in a range from about 8 hours to about 12 hours. Through this process, the grating structure GS may have a polycrystalline structure having a large crystal size.

After the low-temperature heat treatment operation, a high-temperature heat treatment operation for a relatively short time may further be included. For example, the high-temperature heat treatment may be performed at a temperature of about 750° C. or higher within 10 minutes, or at a temperature of about 900° C. or less for 1 minute or more. Defects remaining inside the grating structure GS may be removed by the high-temperature heat treatment, and crystallinity of the grating structure GS may further be improved.

The spatial light modulator 1000 described above may be used as various optical devices, for example, a beam steering device, by adjusting the phase modulation type for each pixel, and may be employed in various electronic devices.

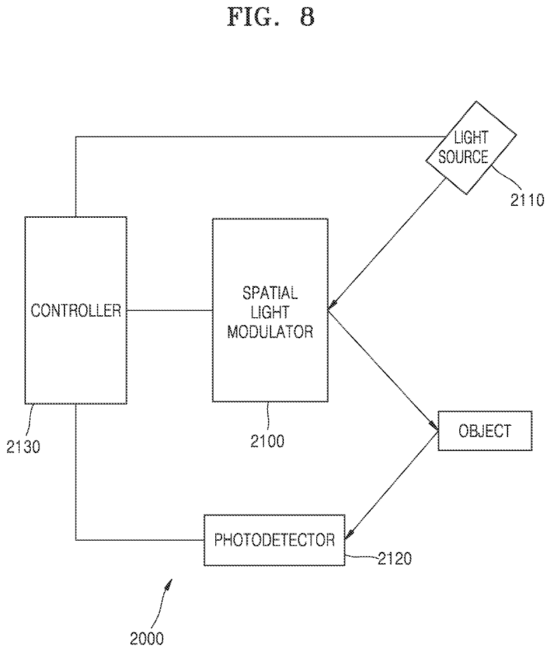

FIG. 8 is a block diagram schematically showing a configuration of a LiDAR device 2000 according to an example embodiment.

Referring to FIG. 8, the LiDAR device 1000 according to an example embodiment may include a light source 2110 configured to emit light, a spatial light modulator 2100 configured to emit light to an object by adjusting a traveling direction of the light emitted from the light source 2110 in a direction toward the object, a photodetector 2120 configured to detect light reflected by the object, in which the light is emitted to the object and a traveling direction of the light is adjusted in the spatial light modulator 2100, and a controller 2130 configured to control the spatial light modulator 2100.

The light source 2110 may include, for example, a light source that emits visible light or a laser diode (LD) or light emitting diode (LED) that emits near-infrared rays in a range of about 800 nm to about 1700 nm. The light source 2110 may include, for example, a light source that emits near-infrared rays in a band range of about 850 nm to about 1100 nm.

The spatial light modulator 2100 may include the spatial light modulator 1000 of FIG. 1. The spatial light modulator 2100 may control a traveling direction of light by modulating a phase of each pixel. The phase modulation for each pixel may be time-sequentially controlled, and accordingly, the traveling direction of light is sequentially adjusted to scan an object. The spatial light modulator 2100 may be used as a beam steering device having high light efficiency and low power consumption.

The controller 2130 may control operations of the spatial light modulator 2100, the light source 2110, and the photodetector 2120. For example, the controller 2130 may control on/off operations of the light source 2110 and the photodetector 2120 and a beam scanning operation of the spatial light modulator 2100. In addition, the controller 2130 may calculate information about the object based on a measurement result of the photodetector 2120.

The LiDAR device 2000 may periodically emit light to various surrounding areas using the spatial light modulator 2100 in order to obtain information on objects in a plurality of surrounding locations.

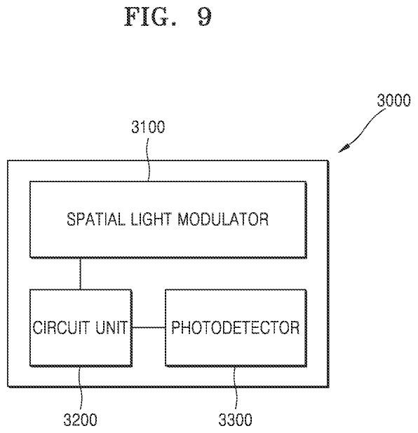

FIG. 9 is a schematic block diagram showing a configuration of a LiDAR device 3000 according to another example embodiment.

Referring to FIG. 9, the LiDAR device 3000 may include a spatial light modulator 3100 and a photodetector 3300 configured to detect light reflected by an object, a traveling direction of the light is controlled by the spatial light modulator 3100. The LiDAR device 3000 may further include a circuit unit 3200 connected to the spatial light modulator 3100 and/or the photodetector 3300. The circuit unit 3200 may include at least one processor that operates as an operation unit that acquires and calculates data, and may further include a driving unit and a controller. In addition, the circuit unit 3200 may further include a power supply unit and a memory.

In FIG. 9, although a case in which the LiDAR device 3000 includes the spatial light modulator 3100 and the photodetector 3300 in a single device is depicted, the spatial light modulator 3100 and the photodetector 3300 may not be provided as a single device, but may be separately provided as a separate device. Also, the circuit unit 3200 may be connected to the spatial light modulator 3100 or the photodetector 3300 through wireless or wired communication. In addition, the configuration of FIG. 9 may be variously changed.

The LiDAR devices of FIGS. 8 and 9 may be devices of a phase-shift method or a time-of-flight (TOF) method.

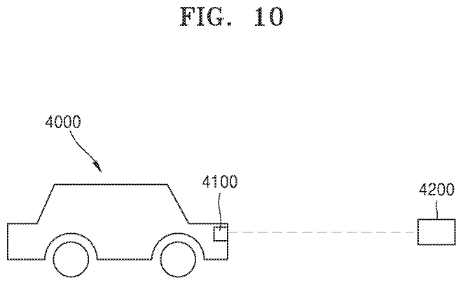

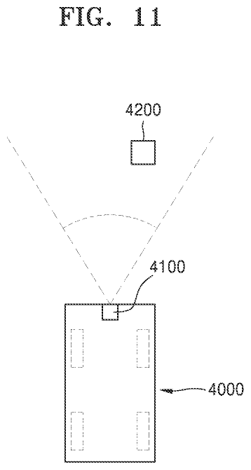

FIGS. 10 and 11 are conceptual views illustrating cases in which a LiDAR device 4100 including a spatial light modulator according to an example embodiment is applied to a vehicle. FIG. 10 is a cross-sectional view of the LiDAR device 4100 viewed from a side, and FIG. 11 is a plan view viewed from above.

Referring to FIG. 10, the LIDAR device 4100 may be applied to a vehicle 4000, and information on an object 4200 may be obtained using the LIDAR device 4100. The vehicle 4000 may be an automobile having an autonomous driving function. The object or a person in a direction in which the vehicle 4000 travels, that is, the object 4200 may be detected using the LI DAR device 4100. In addition, a distance to the object 4200 may be measured using information, such as a time difference between a transmission signal and a detection signal. Also, as shown in FIG. 11, information on a nearby object 4200 and a distant object within a scanning range may be obtained.

The spatial light modulator according to various example embodiments of the disclosure may be applied to various systems other than LiDAR device. For example, when using the spatial light modulator according to various example embodiments, it is possible to obtain 3-dimensional (3D) information of a space and an object through scanning, thus, the spatial light modulator may be applied to a 3D image acquisition device or a 3D camera. Also, the spatial light modulator may be applied to a holographic display device and a structured light generating device. In addition, the spatial light modulator may be applied to various optical devices, such as, for example, a hologram generating device, an optical coupling device, a variable focus lens, and a depth sensor. In addition, the spatial light modulator may be applied to various fields in which metasurfaces or metastructures are used. In addition, the spatial light modulator and the LIDAR device including the spatial light modulator according to an embodiment of the disclosure may be applied for various purposes in various optical and electronic device fields.

According to the disclosed example embodiment, the spatial light modulator may show improved light efficiency by reducing the extinction coefficient k of silicon, for example, the power consumption to obtain the highest SMSR may be reduced.

A LiDAR device employing the spatial light modulator described above may have relatively low power consumption.

According to the manufacturing method described above, a spatial light modulator having relatively high light efficiency is provided.

The spatial light modulator and a LiDAR device including the same have been described with reference to the example embodiment shown in the drawings, but it will be understood by those of ordinary skill in the art that this is merely an example and various changes in form and details may be made therein without departing from the spirit and scope of the disclosure. Therefore, the example embodiments should be considered in descriptive sense only and not for purposes of limitation. The scope of the disclosure is defined not by the detailed description of the disclosure but by the appended claims, and all differences within the scope will be construed as being included in the disclosure.

It should be understood that example embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims.

What is claimed is:

1. A spatial light modulator configured to modulate light, the spatial light modulator comprising:
a first reflective layer;
a resonance layer on the first reflective layer; and
a second reflective layer on the resonance layer, the second reflective layer comprising a plurality of grating structures spaced apart from each other,
wherein the plurality of grating structures comprise silicon (Si) having an extinction coefficient k that is less than or equal to 1e-5 with respect to light in a predetermined wavelength band.

2. The spatial light modulator of claim 1, wherein the silicon is deposited under a process in which a gas flow rate of hydrogen (H₂) is at least twice a gas flow rate of silane (SiH₄).

3. The spatial light modulator of claim 1, wherein the first reflective layer is a distributed Bragg reflective layer.

4. The spatial light modulator of claim 3, wherein the distributed Bragg reflective layer includes silicon (Si), silicon nitride (SiN), silicon oxide (SiO₂), or titanium oxide (TiO₂).

5. The spatial light modulator of claim 1, wherein the first reflective layer is a metal reflective layer.

6. The spatial light modulator of claim 1, wherein the resonance layer includes silicon oxide (SiO₂).

7. The spatial light modulator of claim 1, wherein each of the plurality of grating structures comprises:
a first type semiconductor layer;
a second type semiconductor layer; and
an intrinsic semiconductor layer between the first type semiconductor layer and the second type semiconductor layer.

8. The spatial light modulator of claim 7, wherein a thickness of the first type semiconductor layer and a thickness of the second type semiconductor layer are in a range from 50 nm to 200 nm, and a thickness of the intrinsic semiconductor layer is in a range from 100 nm to 600 nm.

9. The spatial light modulator of claim 1, wherein a reflectance of the second reflective layer is less than a reflectance of the first reflective layer.

10. The spatial light modulator of claim 1, further comprising a first electrode and a second electrode that are configured to apply a voltage to the plurality of grating structures.

11. The spatial light modulator of claim 1, further comprising a dielectric layer on an upper surface of the resonance layer and around the plurality of grating structures.

12. The spatial light modulator of claim 11, wherein a refractive index of the dielectric layer is less than a refractive index of each of the plurality of grating structures.

13. The spatial light modulator of claim 11, wherein the dielectric layer includes at least one of silicon oxide (SiO2) and silicon nitride (SiN).

14. A light detection and ranging (LiDAR) device comprising:
a light source configured to emit light of a predetermined wavelength band;
a spatial light modulator configured to adjust a traveling direction of the light emitted from the light source toward an object; and
a photodetector configured to detect light reflected from the object,
wherein the spatial light modulator comprises:
a first reflective layer;
a resonance layer on the first reflective layer; and
a second reflective layer on the resonance layer, the second reflective layer comprising a plurality of grating structures spaced apart from each other, and
wherein the plurality of grating structures include silicon (Si) having an extinction coefficient k that is less than or equal to 1e-5 with respect to light of the predetermined wavelength band.

15. The LiDAR device of claim 14, wherein the silicon (Si) is deposited under a process in which a gas flow rate of hydrogen (H₂) is at least twice a gas flow rate of silane (SiH₄).

16. A method of manufacturing a spatial light modulator, the method comprising:
forming a resonance layer on a first reflective layer;
forming a semiconductor layer on the resonance layer;
forming a plurality of grating structures spaced apart from each other by patterning the semiconductor layer; and
heat-treating the plurality of grating structures,
wherein the forming the semiconductor layer is performed so that an extinction coefficient (k) of silicon (Si) included in the semiconductor layer with respect to light in a predetermined wavelength band is less than or equal to 1e-5.

17. The method of claim 16, wherein the silicon (Si) is formed by a process in which a gas flow rate of hydrogen (H₂) is at least twice a gas flow rate of silane (SiH₄).

18. The method of claim 16, further comprising filling a dielectric layer between the plurality of grating structures.

19. The method of claim 16, wherein the heat-treating the plurality of grating structures comprises heating the plurality of grating structures at a temperature in a range from 500° C. to 650° C. for 8 hours to 12 hours.

20. The method of claim 19, wherein the heat-treating the plurality of grating structures further comprises heating the heat-treated plurality of grating structures at a temperature greater than or equal to 750° C. within 10 minutes.
